(19) United States
(12) Patent Application Publication
(10) Pub. No.: US 2008/0107109 A1
(43) Pub. Date: May 8, 2008

(54) Method and Apparatus for Managing Multicast Traffic in a Network at the Data Link or Level 2 Layer

(75) Inventor: Ted R. Michaud, Medford, NJ (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/556,271

(22) Filed: Nov. 3, 2006

(51) Int. Cl. H04L 12/56

(52) U.S. Cl. 370/390; 370/401

(57) ABSTRACT

A method using a network bridge to manage multicast transmission is provided. The method begins by receiving a packet from a first source station having a first source address over a data network. The packet includes a first multicast destination address. A table is accessed using the multicast destination address to identify at least one destination station that as a source station has previously transmitted a packet to a destination station having a destination address matching the first multicast destination address. The packet is forwarded over the data network to the destination station

### FIELD OF THE INVENTION

The present invention relates generally to the distribution of multicast messages in a data network and, more specifically, to a network multicast bridging or switching apparatus and method.

### BACKGROUND OF THE INVENTION

Data communication in a computer network involves data exchange between two or more entities such as intermediate stations and end stations, which are interconnected by communication links and subnetworks. The intermediate stations (e.g., a router or switch) interconnects the communication links and subnetworks to enable transmission of data between the endstations. A local area network (LAN) is an example of a subnetwork that provides relatively short distance communication among the interconnected stations, whereas a wide area network (WAN) enables long distance communication over links provided by public or private telecommunications facilities.

As networks have developed, various approaches have been used in the choice of communication characteristics such as communication medium, network topology, message formats, and protocols for channel access. Some of these approaches have been converted into standards. A model of these standards that is often referred to is the International Standards Organization (ISO) Open System Interconnection (OSI) model. This model specifies a hierarchy of protocol layers and defines the function of each layer in a network. Conceptually, each layer in one station carries on a conversation with the corresponding layer in another station with which communication is taking place, in accordance with the protocol defining the rules of this communication. In fact, information is transferred down from layer to layer in one station then through the channel medium and back up the successive layers in the other station.

For purposes of this discussion, only the three lowest layers (out of seven) defined by the OSI Standards need to be considered. These layers are the physical layer, the data link layer and the network layer. The physical layer is the lowest layer (i.e., level 1), which is concerned with the actual transmission of signals across the communication channel and defines the types of cabling, plugs and connectors used in connection with the channel. The next layer, the data link layer (i.e., level 2), serves to transform the physical layer interfacing with the channel into a communication link that appears error-free to the next above layer, which is the network layer (i.e., level 3). The data link layer performs such operations as structuring data into packets or frames and attaching control information and numbers to the packets or frames to enable checking data validity and reinserting reconstructed packets at the right location into the data flow.

Although the data link layer is primarily independent of the nature of the transmission medium, certain aspects of the data link layer functions are dependent on the transmission medium. This is why, in some network architectures, the data link layer is divided into two sublayers: a logical link control sublayer which performs all medium-independent functions of the data link layer, and Media Access Control (MAC) sublayer. The MAC sublayer determines which station should get access to the communication channel when requests for access are in conflict. The functions of the MAC sublayer are more likely to be dependent on the transmission medium.

The basic function of a bridge is to allow stations on different networks or network segments to communicate with each other. A bridge acts at the MAC layer and listens to all message traffic on all networks or network segments to which it is connected, and forwards each message onto the networks other than the one from which the message was received. Bridges also maintain a database of station locations derived from the content of the messages being forwarded. After a bridge has been in operation for some time, it can associate practically every station with a particular port connecting the bridge to the network (e.g. LAN), which contributes to speeding up traffic. A switch is similar to a bridge and provides basic bridge functions such as filtering of data traffic by MAC address, “learning” and forwarding of the frame based on information contained in the data link (MAC) header. While the term bridge is sometimes used to refer to a two port device and the term switch is sometimes used to refer to a device with more than two ports, for the purposes herein they may be used interchangeably.

Unlike a bridge or switch, a router operates at the network layer level instead of the data link layer level, and is fundamentally meant to interconnect unlike network technologies and provide a structured address space (routing based on global address). Addressing at the network layer level, as obtained from the content of the data packet address field, includes a unique network identifier and a target identifier within the network.

The manner in which data packets are transmitted by stations can be classified based on the number of stations that are to receive the packets. In particular, the term unicast describes communication that is transmitted from a source station to a single destination station. The term broadcast describes communication that is transmitted from a source station to all other stations. Finally, the term multicast describes communication that is transmitted from a source station to a select group of other stations. Applications that often use multicasting include video conferencing, corporate communications, distance learning and distribution of software, stock quotes and news.

Multicast transmission is based on the concept of a group. A multicast group is an arbitrary group of receivers that express interest in receiving a particular data stream. Stations that are interested in receiving data intended for a particular group join the group using various protocols. Multicasting is often handled at the network layer by a router. In turn, at the level two layer the bridge will generally simply broadcast the multicast messages, which is an inefficient use of network resources since only a small subset of the stations are generally members of a multicast group. Alternatively, multicasting can also be managed at the level 2 layer using proprietary protocols such as RGMP or, in an IP environment, a technique such as IGMP snooping in which the bridge accesses data from the level three layer. One problem with techniques such as IGMP snooping is that they are relatively software intensive, requiring considerable processing by the bridge, which limits its capacity.

Accordingly, it would be desirable to provide a less process-intensive method and apparatus for managing multicast transmission at the level 2 layer so that both network and bridge capacity can be more efficiently utilized.

### BRIEF DESCRIPTION OF THE DRAWINGS

FIG. 1 is a block diagram of a data network that includes two or more network segments that are interconnected by a bridge or switch.

FIG. 2 illustrates the logical composition of a single packet.

FIG. 3 shows a bridging table for the network configuration shown of FIG. 1.

FIG. 4 shows a reverse learning bridging table for the network configuration in FIG. 1.

FIGS. 5(a)-5(e) show the process by which the reverse learning bridging table of FIG. 4 is populated

FIG. 6 is a flowchart showing an example of the process employed by the bridge to forward packets that belong to a multicast group.

FIG. 7 is a functional hardware block diagram of the bridge or switch shown in FIG. 1.

### DETAILED DESCRIPTION

At the outset it should be noted that each station in a data network has two roles, one when it serves as a source station transmitting packets and another when it serves as a destination station receiving packets. Accordingly, from time to time any given station may be referred to herein as a source station or a destination station, depending of its role at that time.

As detailed below, a so-called reverse learning bridge is used to manage multicasting transmission at the data link or level 2 layer. The term reverse learning bridge is employed because unlike a conventional learning bridge in which the source address of a packet received from a source station is used to populate the bridging table, the destination address of a packet received from a source station is used to populate the bridging table. Whereas a learning bridge is employed to identify the network segment with which a station is associated, a reverse learning bridge is employed to identify those stations that are active members of a multicast group.

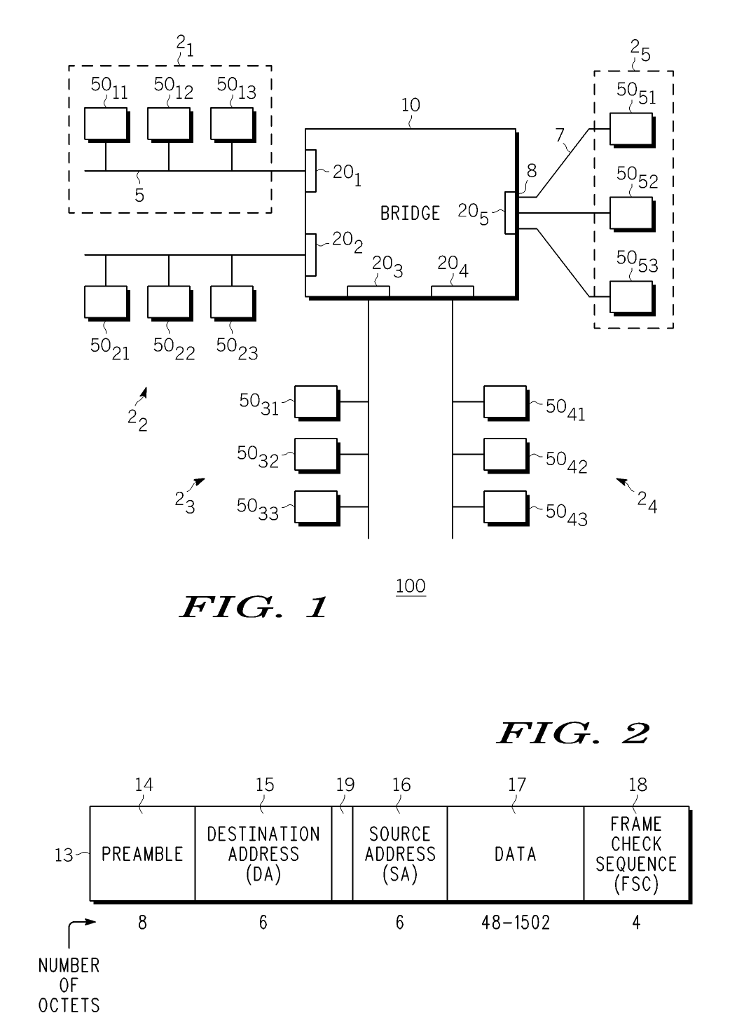

FIG. 1 is a block diagram of a data network 100 that includes two or more network segments that are interconnected by a bridge 10. In the example shown, there are five network segments 2₁, 2₂, 2₃, 2₄ and 2₅. Each network segment has one or more host stations 50. For instance, network segment 2₁ includes stations 50₁₁, 50₁₂ and 50₁₃, network segment 2₂ includes stations 50₂₁, 50₂₂ and 50₂₃, and so on for network segments 2₃, 2₄ and 2₅. The designations 50₂₁, 50₂₂ and 50₂₃ represent the individual MAC address of each station. For instance, station 50₂₁ may refer to a station having a MAC address 00-12-25-00-00-01. Network segments attached to the bridge 10 employ a packet-based data link or level 3 protocol such as Ethernet, Token Ring, FDDI or the like. Other data link protocols may also be employed. The details of Ethernet, Token Ring and FDDI protocols are well known and are documented in standards, particularly in IEEE Standard 802.3 for Ethernet, IEEE Standard 802.5 and ANSI Standard X3T9.5 for FDDI.

Each network segment 2 is connected to one of the ports of the bridge 10. As shown, the bridge 10 provides bridging services to network segment 2₁ through port 20₁, to network segment 2₂ through port 20₂, to network segment 2₃ through port 20₃, to network segment 2₄ through port 20₄ and to network segment 2₅ through port 20₅. The network segments may employ the same or different physical or level 1 layers. For instance, in FIG. 1 the stations on network segment 2₁ are connected to a coaxial cable 5 that serves as the physical medium. The coaxial cable 5 may conform to a well know physical layer standard such 10Base5 or 10Base2. An alternative arrangement making use of 10BaseT technology is shown for network segment 2₅. In this instance, each station is connected via a twisted pair of wires 7 to a unique connection 8 on the port 20₅.

The bridge 10 allows stations on different attached network segments to communicate with each other. There are several advantages to using a bridge rather than simply forming one large common network. By use of a bridge, network segments can be smaller physically (i.e., each segment can contain fewer stations) and, therefore, each segment's electrical limits can be more easily met. From a performance standpoint, the transmission capacity of a segment is limited, and therefore the rate at which messages can be transferred between stations on a segment is limited. By subdividing a large segment into a collection of smaller segments connected by a bridge, the overall usage of a connected segment will be reduced on average. In the illustrated example, for instance, stations on port 20₃, such as 50₃₁ and 50₃₂, may communicate at full segment speed simultaneously while stations on another port, say port 20₄, also use the full capacity of their attached segment.

In order to simplify the following discussion, it will be assumed that all ports employ the Ethernet protocol. Under this protocol, the stations 50 communicate by sending and receiving packets or frames of information. FIG. 2 illustrates the logical composition of a single packet 13. The packet itself consists of a variable number of octets, or 8 bit data units, and is divided into fields of an integral number of octets as shown. The nomenclature and purpose of the fields is as follows. The preamble 14 is a unique set of bits used to synchronize the reception of packets. The destination address 15 is a pattern that specifies the address of the station or stations 50 that are to receive the packet. The source address 16 is a unique pattern specifying the address of the station 50 originating the transmission. Both the destination and source addresses are generally level 2 MAC addresses. The data 17 refers to the data to be transferred from the source station to the destination station. The FCS 18 is a check sequence that is used by the destination stations to assess the validity of the received packet. It should be noted that the term packet is not limited to a block of information that has the particular format depicted in FIG. 2. More generally, as used herein packet refers to a block of data that also includes a destination address, regardless of format. The data in the packet may form all or part of a message. In this context the terms packet, frame, datagram and the like are all largely synonymous.

For purposes of illustration, two destination address formats may be used to distinguish between a packet that is part of a unicast message and a packet that is part of a broadcast or multicast message. As indicated in FIG. 2, the destination address 15 consists of 6 octets, or 48 bits, and one of these bits, the broadcast/multicast flag 19, is used to differentiate between the two destination address formats. For instance, when the broadcast/multicast flag is zero, the destination address is a unique address that identifies a single station. If the remaining bits of the destination address 15 are all ones, then the destination address is considered to designate all stations in the network, including stations on other segments connected to the bridge 10. That is, the destination address designates a broadcast address. In the case where the broadcast/multicast flag 19 is set to one, the destination address 15 is interpreted differently. In the case where the broadcast/multicast flag 19 is one, but the remaining bits of the destination address 15 are not all ones, a multicast packet is indicated. The remaining bits then signify a subset of stations in the network that belong to the multicast group. Such stations may be attached to any one or different segments. In general the identification protocol used to distinguish between message types is application dependent and will not be further specified here. The source address 16 identifies the source station using an addressing scheme as discussed for the destination address 15. The source address 16 does not make use of the broadcast/multicast flag, and thus uniquely identifies the source station originating the packet.

It should be noted that within a single physical network segment 2, such as segment 2₁ that is composed of stations 50₁₁, 50₁₂, and 50₁₃ in FIG. 1, the operation of the packet protocol is straightforward and does not require the use of the bridge 10. Stations transmit packets 13 in which the destination address 15 contains the address of the station they wish to communicate with. Alternately, they can form a destination address 15 so that it has a broadcast address format and the packet 13 will be received by all stations attached to the segment. Each station attached to the segment listens to all transmissions on that segment and checks the destination address of each packet. A packet is intended for a station's address if a non-broadcast destination address matches its station address exactly or if a broadcast/multicast destination address is received. In the case of a broadcast/multicast destination address, the station will receive the packet if the broadcast/multicast address matches according to application-specific rules.

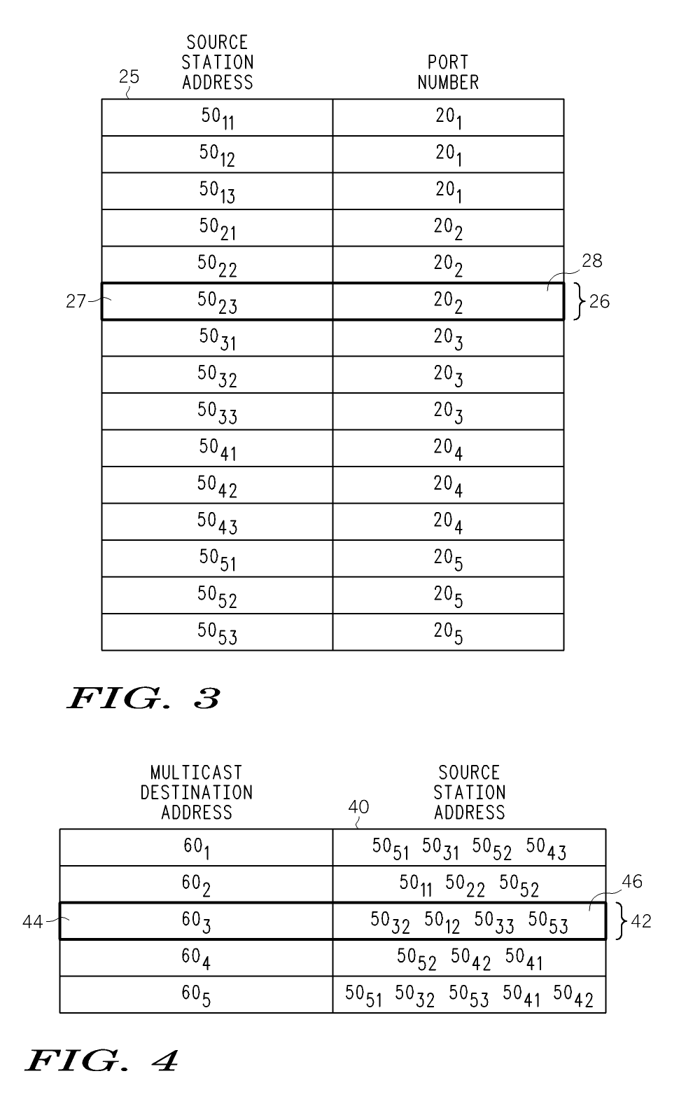

In contrast, when stations on different network segments are to communicate with each other, the bridge 10 is employed. For instance, if station 50₁₂ is to communicate with station 50₄₃, the bridge 10 must pass packets between ports 20₁ and port 20₄. In operation, the bridge 10 examines and evaluates all packet transmissions on its attached ports 20. Using information derived from this process, the bridge builds a bridging table 25, as illustrated in FIG. 3 for the network configuration shown in FIG. 1. There is one bridging table entry 26 for each station currently known to the bridge 10. Each bridging table entry 26 consists of a source address field 27 and the corresponding port number field 28. The port number field 28 indicates the port to which the corresponding station is attached. In bridging table 25, all the bridge-attached station addresses are present in the bridging table 25. Because networks have a dynamic character, it is not necessarily the case that all station address/port number pairs will be in the bridging table 25 at all times.

In a learning bridge, the bridging table 25 is built dynamically, as packets are received from source stations. The bridge 10 examines the source address 16 of each packet received on each port. If the source address 16 of a packet received from a source station matches the source address field 27 of an entry in the bridging table 25 and the port number on which the packet was received matches the port number field 28 of that entry, then the bridging table is not modified. However, if the source address 16 of a packet received from a source station matches a station address field 27 of a bridging table entry 26, but the port number on which the packet was received is not equal to the corresponding port number field 28 for that entry, then the port number field 28 is overwritten with the port number on which the packet was received. However, if the source address 16 of the packet received from the source station does not match the source address field 27 of any bridging table entry 26, then a new entry is added to the bridging table 25. This entry consists of a source address field 27 containing the source address 16 of the source station and a corresponding port number field 28 containing the port number of the port on which the packet was received.

When the bridge is initialized, the bridging table 25 is typically empty. As packets on the attached network segments are examined, bridging table entries 26 are formed and added to the bridging table 25. By this process, the bridge “learns” the correspondence between the attached stations and the ports through which they communicate. Because network configurations can change and stations may be added, removed or moved from one segment to another, the learning bridge generally incorporates an aging algorithm to periodically remove bridging table entries 26 that have not been used for a period of time.

FIG. 4 shows a reverse learning bridging table 40 for the network configuration shown in FIG. 1, which may be employed to identify and maintain a list of stations that are active members of a multicast group. As shown, there is one reverse bridging table entry 42 for each multicast group currently known to the bridge 10. Each entry includes a multicast destination address field 44 and a source address field 46. For each entry 42, the destination address field 44 is populated with a multicast address of a particular multicast group. Five multicast addresses are shown in this example. The five multicast addresses are MAC addresses that are for simplicity represented by designations 60₁, 60₂, 60₃, 60₄, and 60₅. The source address field 46 includes one or more source addresses of source stations that are associated with the multicast group. As previously noted the designation 50ᵢⱼ represents a MAC address for a station j located on network segment 2ᵢ. In one alternative arrangement, the source address field may be replaced with the ports associated with the source addresses. In this way the bridge can avoid the need to perform two lookups, first in the reverse learning bridging table 40 to obtain the appropriate station addresses from the source address field and then in the learning bridging table 25 to obtain the ports on which those stations are located.

As previously noted, at any given time each station in a data network may be functioning as a source station transmitting packets or a destination station receiving packets. In the context of a multicast transmission, the roles of each station may be further specified. For instance, assume that station 50₁₁ is the source of the particular content that is multicast to multiple destination stations in a multicast group. Likewise, assume that station 50₃₃ is one of those destination stations receiving the content from station 50₁₁. At least initially, station 50₃₃ will generally transmit a packet requesting to join the multicast group (or at least to acknowledge that it is or wants to remain a member of the group). When station 50₁₁ is transmitting a packet that includes content to be distributed to the multicast group, it may be referred to hereinafter as a content source station. When station 50₁₁ is receiving a packet from a member of the multicast group, station 50₁₁ may be referred to hereinafter as a request destination station (although as noted above the packet it receives may contain a request, an acknowledgement, or anything else other than the content to be distributed to all the members of the multicast group). When station 50₃₃ is transmitting a packet it may be referred to hereinafter as a request source station. Similarly, when station 50₃₃ is receiving packets from the content source station, it may be referred to herein as a content destination station. It should be emphasized that the terms “content” and “request” as used in this context is simply for the purpose of designating the role any particular station at any particular time and is not to be construed as strictly requiring messages transmitted by either a content source or a request source to contain information relating to either the multicast content or requests to join a multicast group.

Similar to a learning bridging table, the reverse learning bridging table 40 is built dynamically. If the destination address 15 of an incoming packet transmitted by a source station (regardless of whether it is a content source station or a request source station) is a multicast address, the bridge 10 determines if the multicast address corresponds to an entry in the reverse learning bridge table. For example, the bridge 10 looks at the flag bit 19 of packet 13 to determine if the bit is a zero or one. If the bit 19 is a 1, the message is a multicast message. The bridge 10 examines the destination address 15 of each packet received from a source station. If there is not already such an entry, a new entry is created. This is accomplished by copying the multicast destination address from the destination address field 15 of packet 13. The bridge then examines the source address 16 of each received packet and compares it to the address or addresses in the source address field 46 of the entry. If the source address for this source station is already present, the reverse learning bridging entry is not changed. On the other hand, if the source address 16 for this source station is not present in the table, it is added to the source address field 46 for that entry, thereby associating that source station with the particular multicast group identified by the destination address of that entry. This is accomplished by copying the source address from the source address field 16 of packet 13.

The bridge 10 uses the reverse learning bridging table 40 to determine the destination address or addresses to which the multicast packet should be sent. This is accomplished by examining the multicast destination address 15 of an incoming multicast packet, finding its entry in the multicast destination address field 44 of the reverse learning bridging table 40, and retrieving the corresponding address or addresses listed in the source address field 46 for that entry. The packet is then sent to each of the stations having addresses that are obtained in this manner. In this way the packet does not need to be broadcast by the bridge 10, as is often done by conventional bridges. Rather the packet is only forwarded to those content destination stations having source addresses listed in the reverse learning bridge for that entry. Since these source addresses correspond to source stations that have recently sent messages to the multicast group address, they presumably desire to be part of the multicast group represented by that entry. Since the reverse learning bridge only uses information available at the level 2 or data link layer, the bridge 10 can properly forward the messages to the destination stations without the need to obtain any information available at the level 3 of network layer, thus reducing the amount of processing that must be performed by the bridge and hence better utilizing its processing capacity.

Because stations may leave a given multicast group after a period of time, the reverse learning bridge 40 may incorporate an aging algorithm to periodically remove from the entries 42 content destination stations having source addresses that have not participated in the group for a period of time. The aging algorithm specifies a timeout period during which the content destination station is deemed to remain a member of the group. If the timeout period expires without receiving a message from a particular source address, the content destination station having that source address is removed from the reverse learning bridge table 40. On the other hand, when a message is received from a request source station with that particular source address, the timeout period is reset.

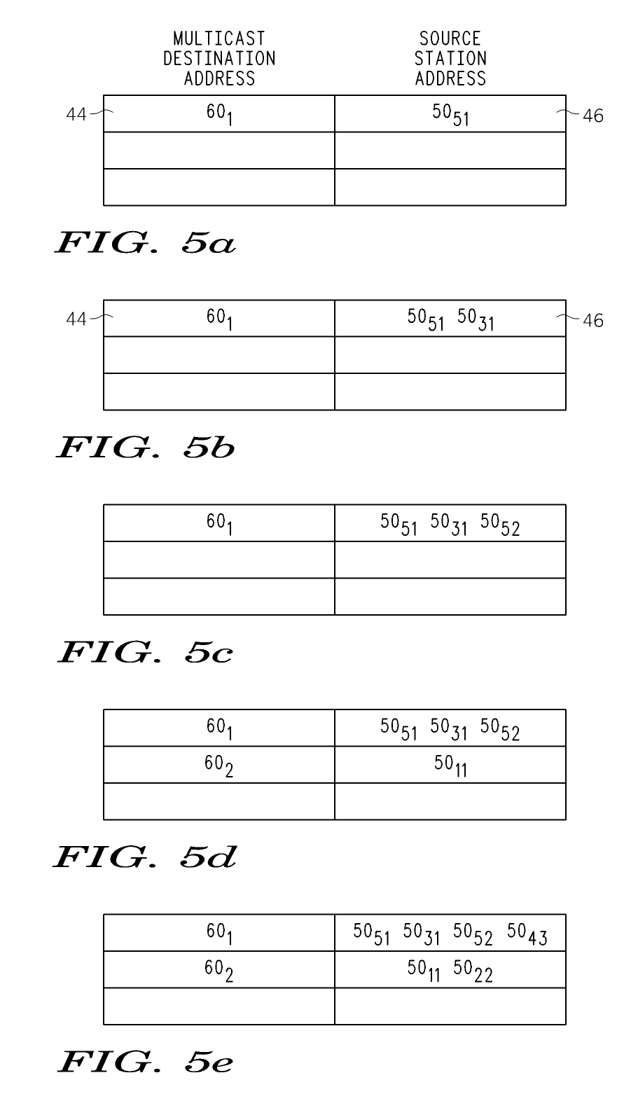

The following example, which will be discussed in connection with FIGS. 5a-5d, will illustrate how the reverse learning bridging table of FIG. 4 is populated before any multicast groups have been established. That is, in this example the fields of the reverse learning bridging table are initially empty. Assume bridge 10 receives a message from say, station 50₅₁. As previously noted the designation 50₅₁ represents a MAC address of the station. This message is a request to join a multicast group in which station 50₃₁ is the source. The message is recognized by the bridge 10 as a multicast message having a multicast destination address that is associated with the multicast. For purposes of illustration the multicast destination address will be assumed to be the MAC address 60₁. The bridge 10 examines its reverse learning bridge table and determines that there is no entry for this multicast destination address. Accordingly, the bridge 10 broadcasts the message and establishes a new entry. The new entry is created by adding the multicast destination address 60₁ to the multicast destination address field 44 of this entry in the reverse learning bridging table. Since the message was received from station 50₅₁, this station address is listed in the source address field 46 of this new entry. FIG. 5a shows the newly established entry with the MAC addresses stations 50₅₁ and 60₁ entered in the appropriate fields. Station 50₃₁ receives the message and responds by sending an acknowledgement message or the like. The bridge 10 receives the acknowledgement message and, noting that its destination address is the multicast MAC address 60₁, adds the source address 50₃₁ to the source address field 46 of this entry (see FIG. 5b) before transmitting a subsequent message.

Next, the bridge 10 may receive a message from, say, station 50₅₂ requesting to the join the multicast group of station 50₃₁. The bridge 10 examines its reverse learning bridging table and determines that it already has an entry for this multicast group. However, since the station 50₅₂ from which the message was received is not listed in this entry, it is added to the source address field 46 of this entry (see FIG. 5c). The message is then forwarded on to the destination station 50₃₁ as well as the other station (station 50₅₁) listed in the source address field 46 for this entry. Station 50₃₁ once again responds by sending an acknowledgement message or the like.

The bridge 10 then receives a multicast message from station 50₁₁ requesting to join a multicast group having a multicast destination address 60₂. Station 50₂₂ is the source of the content. Once again, the bridge 10 examines its reverse learning bridging table and determines that there is no entry for the multicast destination address 60₂ associated with this multicast message. Accordingly, the bridge 10 establishes a second new entry and adds the multicast destination address 60₂ to the multicast destination address field 44 of this second new entry in the reverse learning bridging table. Since the message was received from station 50₁₁, this station address is listed in the source address field 46 of this second new entry. FIG. 5d shows the newly established entry with the addresses 50₁₁ and 60₂ entered in the appropriate fields. The message is then broadcast to all devices connected to the bridge 10, including destination station 50₂₂, which responds in the appropriate manner. The bridge examines this response and adds the station 50₂₂ to the source station address field 46 for this entry (FIG. 5e).

The bridge 10 next receives a multicast message from station 50₄₃ requesting to join the multicast group associated with the multicast MAC address 60₁. The bridge 10 examines its reverse learning bridging table and determines that it already has an entry for this multicast group. However, since the station 50₄₃ from which the message was received is not listed in this entry, it is added to the source address field 46 of this entry (see FIG. 5e). The message is then forwarded on to the multicast MAC address 60₁ as well as the other stations (stations 50₅₁, 50₃₁ and 50₅₂) listed in the source address field 46 for this entry. The reverse learning bridging bridge continues to be populated in this manner until all the entries shown in FIG. 4 has been added. It should be noted that in the above example the incoming multicast messages were assumed to be messages requesting to join a multicast group. However, the reverse learning bridging table is populated in the same manner regardless of the content of the message.

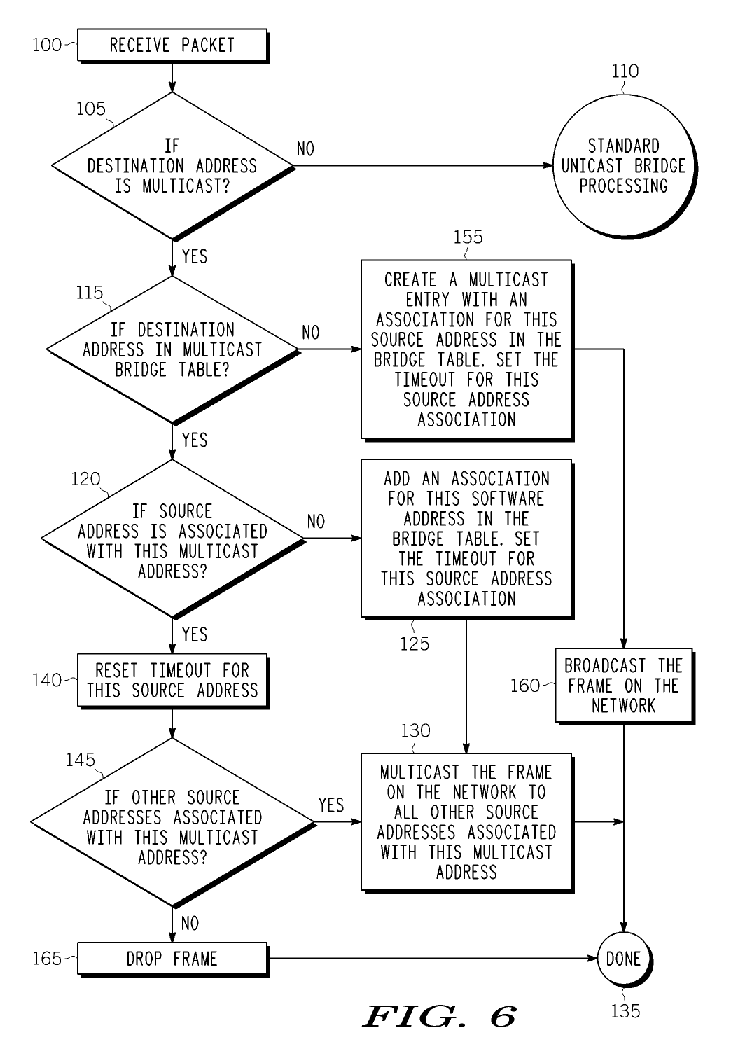

FIG. 6 is a flowchart showing an example of the process employed by bridge 10 to forward packets that belong to a multicast group. The process begins at step 100 when the bridge receives a packet from one of the stations 50. The bridge examines the destination address in step 105 to determine if the packet is part of a multicast message or a unicast or broadcast message. If the message is a broadcast or unicast message, the process continues in step 110 using conventional bridging processes. If, on the other hand, the message is a multicast message (regardless of whether it is received from a station acting as either a content source station or a request source station), the process proceeds to step 115, where the bridge determines if the destination address of the message or packet corresponds to an entry in the reverse learning bridge table. If it does, then the process proceeds to step 120 in which the bridge examines the source address of the incoming packet and compares it to the source addresses of the source stations listed in the source address field of the reverse learning bridge for the designated entry. If the source address is not present in the table, the bridge adds the source address for this source station to the source address field for the designated entry in step 125 and establishes a timeout for it. The timeout may be implemented in the same or a similar manner that it is implemented in a learning bridge. Then, in step 130 the bridge forwards the packet to all the stations having addresses present in the source address field of the designated entry, after which the process terminates in step 135.

Returning to step 120 in which the bridge examines the source address of the incoming packet received from a source station, if the source address does correspond to an address in the designated entry of the reverse learning bridge table, then in step 140 the bridge resets the timeout for that particular station. In step 145 the bridge determines if any other source addresses are associated with the multicast group of the designated entry. The process then continues with step 130, where the packet is forwarded to all stations with addresses present in the source address field for the designated entry, including the station of the incoming packet, which has just been added to the table. Alternatively, if there are no other stations having source addresses associated with the designated entry, the bridge simply drops the packet in step 165 since it does not need to be forwarded to any other stations. In either case, the process once again terminates in step 135.

Returning to step 115, if the bridge determines that the destination address of the incoming packet does not correspond to an entry in the reverse learning bridge table, in step 155 it creates a new entry in the table, which represents a new multicast group. The destination address is added to the destination address field of the new entry and the source address of the packet is added to the source address field of the new entry. The message is then broadcast over the network in step 160. A timeout is also established for the station with the source address that has just been added to the table. The process then continues with step 130 as before.

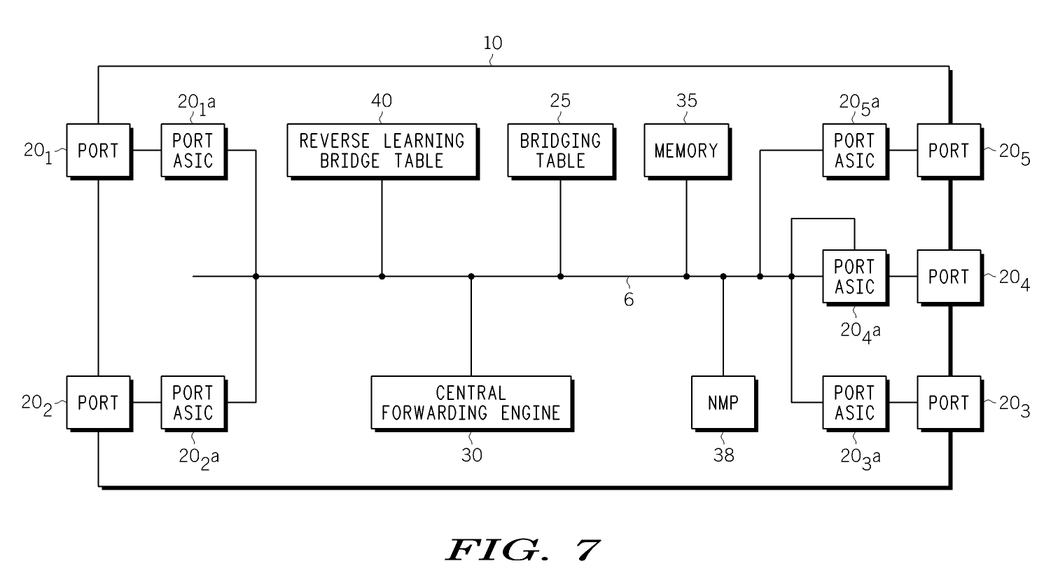

FIG. 7 is a functional hardware block diagram of the bridge or switch 10 shown in FIG. 1. The various elements within the bridge 10, apart from most of the memory, can be provided on a single ASIC (application specific integrated circuit). However, for ease of explanation, the various elements of the bridge are separately shown in FIG. 7. Of course, the particular functional elements set forth in the figures above are shown for purposes of clarity only and do not necessarily correspond to discrete physical elements. Moreover, the various functional elements may be performed in hardware, software, firmware, or any combination thereof

Each of the ports 20₁, 20₂, 20₃, 20₄, and 20₅ has a respective port ASIC 20₁a, 20₂a, 20₃a, 20₄a and 20₅a respectively. These components include the media access control devices (MACs), which perform known operations on packets entering and leaving the bridge while the packets are in a format independent of the particular transmission medium to which a respective port is connected. The port ASICs also include a physical layer device, which not only converts packets from a media independent format to a format appropriate for the particular transmission medium, but also includes various other functions such as auto-negotiation, for example, particularly in the case of Ethernet networks described in IEEE Standard 802.3.

The bridge 10 includes a bus system 6 by means of which packet data and control and status data are conveyed between the various components of the bridge 10. The bridge 10 switch includes a bridging table 25 and reverse learning bridging table 40, a memory 35 which may be employed for the temporary storage of packets in queues before they are sent to their destination ports, and a central forwarding engine 30. The bridging table 25 and the reverse learning bridge table 40 may located in the same or a different memory. The central forwarding engine 30 will retrieve packets temporarily stored in memory 35 and direct them to respective ports in accordance with, for example, relevant entries in the bridging table 25 and the reverse learning bridge table 40. The central forwarding engine 30 includes programmable control and forwarding logic for providing appropriate commands to other elements (e.g., the switch ports) to cause packets received by the bridge 10 to be forwarded to appropriate network segments coupled to the bridge 10 based upon configuration information. Central forwarding engine 30 and bridging tables 25 and 40 are each coupled to network management processor (NMP) 38. NMP 38 is coupled to bus 6. When a packet is received by any of the ports 20 of the bridge 10, the corresponding port ASIC 20a respectively transmits the packet to bus 6. The packet is broadcast via bus 6 so as to make the information contained in the packet available to the central forwarding engine 30, and NMP 38.

The processes described above in connection with bridge 10 may be implemented in general, multi-purpose or single purpose processors respectively associated with the bridge 10. Such a processor will execute instructions, either at the assembly, compiled or MAChine-level, to perform that process. Those instructions can be written by one of ordinary skill in the art following the description of presented above and stored or transmitted on a computer readable medium. The instructions may also be created using source code or any other known computer-aided design tool. A computer readable medium may be any medium capable of carrying those instructions and include a CD-ROM, DVD, magnetic or other optical disc, tape, silicon memory (e.g., removable, non-removable, volatile or non-volatile), packetized or non-packetized wireline or wireless transmission signals.

1. At least one computer-readable medium encoded with instructions which, when executed by a processor, performs a method including:
receiving a packet from a first source station having a first source address over a data network, wherein the packet includes a first multicast destination address; and
accessing a table using the multicast destination address to identify at least one destination station that as a source station has previously transmitted a packet to a destination station having a destination address matching the first multicast destination address; and
forwarding the packet over the data network to said at least one destination station

2. The computer-readable medium of claim 1 wherein the table includes a set of destination fields and a set of source fields and further comprising comparing the first multicast destination address of the packet to a destination address field of the multicast bridging table and, if a match is found in the destination address field of a particular entry, forwarding the packet to each station having a source address listed in the source address field of the particular entry.

3. The computer-readable medium of claim 2 wherein if no match is found, adding a new entry in the table and adding the first destination address of the packet received from the first source station to the destination address field of the new entry and adding the first source address of the packet received from the first source station to the source address field of the new entry.

4. The computer-readable medium of claim 2 further comprising comparing the first source address of the packet received from the first source station to a source address field of the particular entry, and if no match is found, adding the source address to the source address field of the particular entry.

5. The computer-readable medium of claim 1 wherein the source addresses and the destination address are level 2 layer addresses.

6. The computer-readable medium of claim 1 wherein the source addresses and the destination address are MAC addresses.

7. The computer-readable medium of claim 2 further comprising a timeout period for the first source station during which the first source address continues to remain in the source address field of the particular entry.

8. The computer-readable medium of claim 2 further comprising removing the first source address from the particular entry of the table upon expiration of a timeout period during which no additional packets have been received from the first source station.

9. The computer-readable medium of claim 7 further comprising removing the first source address from the particular entry of the table upon expiration of the timeout period during which no additional packets have been received from the first source station.

10. A network bridge, comprising:
a plurality of ports for receiving and transmitting data packets over a data network;
a database configurable for relating multicast destination addresses of incoming packets to a source address of the incoming packets; and
a forwarding engine for forwarding the incoming packets based on their respective multicast destination addresses listed in the database.

11. The network bridge of claim 10 wherein the database is configured to maintain a plurality of entries each associated with a multicast group and each relating a different multicast destination address of incoming packets with at least one source address of the incoming packets and wherein the forwarding engine forwards the incoming packet to the at least one source address located in the entry associated with the multicast destination address of the incoming packet.

12. The network bridge of claim 10 further comprising a processor for populating the database with at least one entry that includes a destination address field containing a first multicast destination address of one of the incoming packets and a source address field containing one or more source addresses of incoming packets that have the first multicast destination address.

13. The network bridge of claim 10 wherein the source addresses and the destination address are level 2 layer addresses.

14. The network bridge of claim 10 wherein the source addresses and the destination address are MAC addresses.

15. At least one computer-readable medium encoded with instructions which, when executed by a processor, performs a method including:
receiving a packet from a first source station having a first source address over a data network, wherein the packet includes a first multicast destination address; and
determining if the multicast destination address corresponds to an existing entry in a reverse learning bridging table, and if not, creating a new entry in the table and adding the first multicast destination address of the packet received from the first source station to the destination address field of the new entry and adding the first source address of the packet received from the first source station to the source address field of the new entry.

16. The computer-readable medium of claim 15 wherein if the multicast destination address does correspond to an existing entry in the reverse learning bridge table, comparing the first source address of the packet received from the first source address station to source addresses listed in the source address field of the entry and if not already present therein, adding the first source address thereto.

17. The computer-readable medium of claim 15 wherein the source addresses and the destination address are level 2 layer addresses.

18. The computer-readable medium of claim 15 wherein the source addresses and the destination address are MAC addresses.

19. The computer-readable medium of claim 15 further comprising establishing a timeout period for the first source station during which the first source address continues to remain in the source address field of the existing entry.

20. The computer-readable medium of claim 15 further comprising removing the first source address from the existing entry of the table upon expiration of a timeout period during which no additional packets have been received from the first source station.

21. The computer-readable medium of claim 19 further comprising removing the first source address from the existing entry of the table upon expiration of the timeout period during which no additional packets have been received from the first source station.
